(19) United States
(12) Patent Application Publication
(10) Pub. No.: US 2003/0208511 A1
(43) Pub. Date: Nov. 6, 2003

(54) Database replication system

(76) Inventors: LeRoy D. Earl, Maple Grove, MN (US); Sergey Igorevich Oderov, Moscow (RU)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/426,467

(22) Filed: Apr. 30, 2003

Related U.S. Application Data
(60) Provisional application No. 60/380,053, filed on May 2, 2002.

(51) Int. Cl. G06F 12/00

(52) U.S. Cl. 707/204

(57) ABSTRACT

A method for online, real-time, continuous replication of a database includes a process for initially copying a database from one or more source servers to a destination server, processes for scanning database transaction log files and database data files to identify when data has changed, processes for replicating changed data from the source server to the destination server, and processes to ensure that the source and destination databases are continually synchronized. The inventive method is self-healing and can recover and resume without loss of data even if the replication process is slowed, interrupted, or halted.

### CROSS-REFERENCE TO RELATED APPLICATION

This application claims the benefit of U.S. Provisional Application No. 60/380,053, titled “Echostream System” and filed May 2, 2002, the contents of which are incorporated herein by reference.

### BACKGROUND OF THE INVENTION

The present invention relates to real-time ongoing replication of computer databases such as Oracle and DB2, using a software-only solution that does not require proprietary hardware.

For modern organizations, information means money. Twenty-first century computer technology has made organizations increasingly dependent on computer systems to store and to access the information that is crucial to the success of their daily operations. Because the data stored on these computer systems is so crucial, its constant availability has become essential. Any interruption in immediate access to this data, even temporarily, can be extremely detrimental, and any loss of data can have catastrophic consequences.

In the past, organizations provided data redundancy by backing up their disk drives to tape overnight and then storing those tape backups at a secure, off-site location. This solution always had two weaknesses. First, if an organization lost its primary computer facilities, the tape backups had to be transported to an alternate location and the data had to be loaded onto an alternate computer system; in the meantime, the organization would not have access to its data. Second, if the failure occurred during the day, all transactions that had been entered during the day would be lost.

In the past, these limitations were not as crucial as they are today. For example, when organizations collected transactions on paper during the day and then processed them in batches overnight, the paper transactions served as the organization's backup. Today, however, most organizations are entering transactions online throughout the day (and even at night). Increasingly, the source of many of these transactions is electronic (orders placed on the Internet, electronic transfers, etc.).

In this environment, orders are continually being taken, records are always being updated, merchandize is being moved, and decisions are being made based on data already recorded on computer databases. Organizations have become increasingly reliant on instant access to information entered earlier in the day to conduct their daily operations.

As a result, there has been a growing need for computer hardware and software solutions that enable organizations to copy their data continually throughout the day and night, replicating that data to local or remote destination servers over local or wide area networks. At the same time, however, transaction volumes have been increasing, making it necessary for these solutions to replicate data faster and more efficiently.

In addition, the increasing use of complex databases such as Oracle and DB2 have added to the data replication challenge. Not only are databases larger than older, more traditional “flat” files; they are also more complex. There are relationships and connections between various pieces of data that must be preserved and synchronized or the database will be “corrupted”. For example, a change to a customer's shipping address may have to be applied to pending orders already in the system.

As a result, data replication solutions now need to be “self-healing;” that is, they need to be able to handle various interruptions in the process (loss of a network connection or downtime on a server, for example) while preserving the database's integrity and preventing its corruption. Some organizations also need the ability to efficiently create “snapshot” copies of their databases, enabling them, for example, to revert to a clean copy of the database from an hour ago if an operational problem has corrupted their database in the last 25 minutes.

Furthermore, as increasing numbers of organizations move towards 24-hour operations, data replication solutions need to be installable and configurable without bringing down databases that are being updated around the clock. They also need replication solutions that can keep current with database transactions in both high and low-volume conditions.

### SUMMARY OF THE INVENTION

Data Replication System's incorporating the present invention include software sold under the trademark H.A. ECHOSTREAM, which is a disk storage management solution that provides automatic replication of data in real-time. Whenever data files are updated on a source (primary) server, the software replicates those data files onto a destination (i.e., secondary, target, or backup) server and keeps each server synchronized with the other. Thus, the destination (secondary) server functions as a “mirrored” server.

Various embodiments of the present invention are included in one or more of the three versions of the H.A. ECHOSTREAM brand software sold by assignee of the present invention. The three versions of the software are known as, and referred herein as:

1. H.A. ECHOSTREAM Version 1.

2. H.A. ECHOSTREAM Version 1-Plus.

3. H.A. ECHOSTREAM Version 2.

Generally speaking, the capabilities of the H.A. ECHOSTREAM Version 1 version are included in H.A. ECHOSTREAM Version 1-Plus and Version 2 versions. Also generally speaking, H.A. ECHOSTREAM Version 1-Plus and Version 2 each have unique additional features.

H.A. ECHOSTREAM Version 1:

H.A. ECHOSTREAM Version 1 works by continually scanning all database files (including database data files, database transaction log files, and database control files) and replicating all database changes. It begins by performing an initial copy of all database files from the source server to the destination server. If the customer elects to use the periodic “snapshot” copy capability, the database is also copied to a snapshot copy on the destination server. During this initial copy it also records any updates made to the database on the source server in Temporary Buffer Files, so these updates can be replicated after the initial copy is completed.

Once the initial copy is completed, H.A. ECHOSTREAM scans the entire database on the destination server and builds a set of sophisticated control tables. If it is working with an Oracle database, it builds a File Control Table for each Oracle CTL, DBF, and LOG file. Each 12-byte Block Entry in each File Control Table contains a unique, calculated set of control and hash totals for each 32 KB physical block of data in the file. In addition, there is a Master Control Table that has a File Entry for each database file, containing the date and time each file was last changed.

As soon as H.A. ECHOSTREAM has built the H.A. ECHOSTREAM File Control Tables and the H.A. ECHOSTREAM Master Control Table summarizing the initial copied data on the destination server, the tables are transferred into memory in the DB Image Storage on the source server and are removed from the destination server.

Regular data replication now begins automatically. Since the Control Tables contain control and hash totals for each 32 KB portion of all the data on the destination server, H.A. ECHOSTREAM can now compare them against similar control and hash totals for each 32 KB portion of data on the source server to determine whether the data has changed and needs to be replicated to the destination server.

At regular, customer-controlled intervals, such as every three (3) seconds (set via the Set DB Check Interval option under the DB Repl. Management option on the Options menu), H.A. ECHOSTREAM—on the source server—compares the date and time each database file was last modified on the source server against the date and time entries in the H.A. ECHOSTREAM Master Control File. If the date and time of any file is later than the entries in the table, then H.A. ECHOSTREAM begins an H.A. ECHOSTREAM Replication Transaction.

At the start of an H.A. ECHOSTREAM Replication Transaction, H.A. ECHOSTREAM checks the date and time stamp for each database file on the source server against the corresponding entries in the H.A. ECHOSTREAM Master Control Table to see if any of the files has changed.

If any have changed, an H.A. ECHOSTREAM Replication Transaction is begun. For each file that has changed, it calculates a new set of control and hash totals for each 32 KB physical block of date, and compares that new set of totals against the existing Block Entry in the H.A. ECHOSTREAM File Control Table. If the new set of totals is different, then there has been a change in that data since it was last copied or replicated to the destination server; as a result, that changed 32 KB block of data is written first to one of two Temporary Buffer Files on the source server. Later, it will be sent to a H.A. ECHOSTREAM Temporary Replication Log File on the destination server. (There can be multiple occurrences of this file.)

This process is repeated for all of the 32 KB physical blocks of data that have changed on all of the database files that have a date and time saved that is later than those logged in the H.A. ECHOSTREAM Master Control Table. This constitutes an H.A. ECHOSTREAM Replication Transaction. To ensure that all physical blocks are replicated on logical groups, the software checks each database file to determine if it has been updated while it is being scanned; if it has, it restarts the scan process.

Periodically, depending on how busy the database is, H.A. ECHOSTREAM stops writing to one Temporary Buffer File and starts writing to the other Temporary Buffer File. (Of course, if the other Temporary Buffer File is still being processed by the destination server, H.A. ECHOSTREAM on the source server will not switch to that buffer file.) Once H.A. ECHOSTREAM switches to using the other buffer (there are two) on the source server, the data changes on the original buffer are replicated from the Temporary Buffer File on the source server to a Temporary Replication Log File on the destination server.

After the changes are written to this temporary file on the destination server and the destination server updates the backup database and sends a verification message back to the source server, H.A. ECHOSTREAM updates the Block Entries in the H.A. ECHOSTREAM File Control Tables in the DB Image Storage on the source server for the 32 KB changes in that transaction and updates the date and time information in the File Entries in the H.A. ECHOSTREAM Master Control File on the source server. This process ensures that the destination database is not corrupted by a partially-completed database update.

Once the H.A. ECHOSTREAM Temporary Replication Log File is written on the destination server, H.A. ECHOSTREAM on the destination server reads the file and makes the specified updates on the copy of the database on the destination server.

Once all the transactions in an H.A. ECHOSTREAM Temporary Replication Log File are processed, the file is deleted.

If the destination server is too busy to process the transactions in one of the Temporary Buffer Files, H.A. ECHOSTREAM simply continues to write database changes to the other Temporary Buffer File on the source server. (Database changes in each buffer are always processed in a first-in-first-out fashion.) Once the other buffer becomes free, H.A. ECHOSTREAM begins to write database changes to that buffer so the changes in the previous buffer can be passed to the destination server.

The transaction process starts again as H.A. ECHOSTREAM once again scans the H.A. ECHOSTREAM Master Control File entries against the date and time stamps on each Oracle database file.

H.A. ECHOSTREAM provides the optional ability to capture a snapshot of the database on the destination server on a scheduled basis, to provide protection should the database become corrupted on the source server and then be replicated to the destination server. The snapshots will allow the customer to restore the database to the point in time when the latest snapshot was recorded.

If the snapshot feature is turned on, H.A. ECHOSTREAM maintains a temporary file on the destination server, listing all of the 32 KB blocks of data that have been changed since the last snapshot was made. When it is time to update the snapshot at a scheduled time, H.A. ECHOSTREAM scans those entries and replicates each of those 32 KB blocks of data from the destination copy of the database to the snapshot copy.

If the network connection between the source server and the destination server is lost, but both servers are up, then replication is halted. If the network connection is lost in the middle of an H.A. ECHOSTREAM Replication Transaction, the half-finished transaction is discarded on the destination server, but that transaction still exists in the Temporary Buffer File on the source server. Any transactions already stored in the Temporary Replication Log Files on the destination server will be processed.

During the time the network connection is lost, H.A. ECHOSTREAM continues to store database changes in the other Temporary Buffer File on the source server. When the network connection is restored, H.A. ECHOSTREAM picks up where it left off in processing the Temporary Buffer File that was being passed to the destination server at the time the network connection was lost. When that Temporary Buffer File is processed, H.A. ECHOSTREAM then switches to processing the Temporary Buffer File that contains the database changes that accumulated while the database connection was lost.

If the customer clicks on Stop (Replication), due to network or server problems, H.A. ECHOSTREAM stops saving transactions in the Temporary Buffer Files on the source server and discards the existing contents. Later, when the customer clicks on Start (Replication), H.A. ECHOSTREAM rescans the entire database copy on the destination server, recreates all the File Control Tables and the Master Control Table, recopies them into the DB Image Storage on the source server, compares the control tables against the database on the source server, and begins replicating any changes that have not yet been made on the destination server. Depending on how long the network connection has been lost and how busy the source server has been, this catch-up may take awhile.

If the source server crashes, then replication is halted. If the source server crashes in the middle of an H.A. ECHOSTREAM Replication Transaction that is being passed from the Temporary Buffer File, the half-finished transaction is discarded and not recorded in the Temporary Replication Log File on the destination server. This ensures that the destination database is not corrupted by a partially-complete database transaction. However, if there are any pending transactions that were successfully and completely written to the Temporary Replication Log File, H.A. ECHOSTREAM will post these changes to the destination database on the destination server.

If the crash of the source server is a catastrophic failure and the source database is lost, then the database updates contained in that single half-finished transaction will also be lost. In addition, any database changes stored in the Temporary Buffer Files on the source server that had not yet been passed to the Temporary Replication Log File on the destination server will also be lost. This should only be a problem if there is a backlog of database changes in those buffers at the time the source server failed.

If there is no catastrophic failure and no loss of data on the source server and the source server is restarted and the customer clicks on Start (Replication), on the source server (after clicking on Start [Replication] on the destination server), H.A. ECHOSTREAM rescans all of the database files on the destination server, recreates all of the H.A. ECHOSTREAM File Control Tables and the Master Control Table, recopies them into the DB Image Storage on the source server, compares the control tables against the database on the source server, and begins replicating any changes that have not yet been made on the destination server. Depending on how long the network connection has been lost and how busy the source server has been, this catch-up may take awhile.

If the destination server crashes, then replication is halted. If the destination server crashes in the middle of an H.A. ECHOSTREAM Replication Transaction, the half-finished transaction is lost. If there is no catastrophic failure and the destination server is restarted and the customer clicks on Start (Replication) on the Data Replication Control Centerwindow, H.A. ECHOSTREAM scans all of the database files on the destination server, recreates all of the H.A. ECHOSTREAM control tables, recopies them into the DB Image Storage on the source server, compares the control tables against the database on the source server, and begins replicating any changes that have not yet been made on the destination server. Depending on how long the network connection has been lost and how busy the source server has been, this catch-up may take awhile.

If the customer loses the database on the source server, the customer can restore the database from either the destination database or the snapshot database on the destination server. Care must be taken when performing this restore to ensure that any existing database on the source server is first cleaned.

To recover the source server from the copy of the database on the destination server, the user selects Recovery on the main Data Replication Control Center window.

To recover the source server from the snapshot copy of the database on the destination server, the user selects Recovery on the main Data Replication Control Center window and then selects Snapshot Recovery. This process will first copy the snapshot copy of the database on top of the backup copy on the destination server and will then copy that copy to the source server.

If the customer loses the database on the destination server, the customer can recopy the database from the source server, using the initial copy function.

H.A. ECHOSTREAM Version 1 also has the ability to replicate from many source servers to a single destination server. This capability allows the customer to specify the location where each source database should be replicated on the destination server, and permits customers to use a single remote destination server as the backup server for multiple locations.

H.A. ECHOSTREAM Version 1-Plus:

H.A. ECHOSTREAM Version 1-Plus has an additional unique feature that speeds up data replication on larger databases by taking advantage of an inherent database recovery capability. For example, when an Oracle database starts up, it automatically “recovers” any database updates that appear in the two latest database log (.LOG) files but do not yet appear in the database data (.DBF) files.

H.A. ECHOSTREAM Version 1-Plus uses this capability to modify how H.A. ECHOSTREAM Version 1 scans for database updates. If the scanning process scans a database data (.DBF) file and then discovers that the file has been updated since the scan began, it does not repeat the scan again as it does in H.A. ECHOSTREAM Version 1. Instead, the H.A. ECHOSTREAM Version 1-Plus scanning process then checks the database log (.LOG) files to determine how many log files have been updated since that data replication transaction began. If two or fewer log files have been updated, then the scanning process does nothing, since Oracle itself could recover any transactions if the database crashed at that moment. If, however, the scanning process finds that more than two log files have been updated, then data replication must occur, so it starts to rescan the database data (.DBF) files.

This approach avoids consuming cycle time by repeatedly scanning database files in a fruitless attempt to continue data replication at the very same time that the database itself is extremely busy. Instead, it replicates data only when it is actually necessary to do so.

H.A. ECHOSTREAM Version 2:

On databases such as Oracle, the actual database files (.DBF files) are much larger than the transaction log files (.LOG), and it can be prohibitively time-consuming to continually scan database data (.DBF) files on large databases. As a result, H.A. ECHOSTREAM Version 2 scans the much smaller database log (.LOG) files first, and only scans the much larger database data (.DBF) files when it encounters a change to a database log (.LOG) file. Two techniques are used to accomplish this

First, the data replication process is controlled by a process that continually scans and replicates the database log (.LOG) files. This process is used to determine what database changes have been made; when changes are found on the transaction log files (.LOG), H.A. ECHOSTREAM Version 2 looks for and replicates changes made to the database data (.DBF) files. Second, when H.A. ECHOSTREAM scans the database log (.LOG) files, it does not scan the entire log file but just the header blocks to determine whether any data has changed. This use of the database log (.LOG) files to drive the replication process means H.A. ECHOSTREAM Version 2 (Database) can keep up with very high transaction volumes while ensuring that all pending transactions are replicated in the event of a failure.

In addition, since H.A. ECHOSTREAM Version 2 continually scans and replicates the database log (.LOG) files, it can detect and keep current on database changes even during extremely low transaction volumes. This is because databases such as Oracle typically do not update their database data (.DBF) files continually, but only when a specified time control point is reached or when a database log (.LOG) files fills up, whichever comes first. Thus, when transaction volumes are extremely low, Oracle may be writing occasional changes to the database log (.LOG) file but not to the database data (.DBF) files. H.A. ECHOSTREAM Version 2, however, replicates the changes made to the database log (.LOG) file. If a failure occurs at this point, and control is passed to the destination server, Oracle will see the pending transactions in the database log (.LOG) file on the destination server and will update the appropriate database data (.DBF) files, thus ensuring that these pending transactions are not lost.

### BRIEF DESCRIPTION OF THE DRAWINGS

FIG. 1 is an H.A. ECHOSTREAM Version 1 object-based data control flow diagram.

FIG. 2 is an H.A. ECHOSTREAM Version 1 data control flow diagram for tDBObserver object.

FIG. 3: is an H.A. ECHOSTREAM Version 1 data control flow diagram for ConnectHandler, tlOServer, and tSnapShot objects.

FIG. 4 is an H.A. ECHOSTREAM Version 1 Timeline for Oracle's database writing process.

FIG. 5 is an H.A. ECHOSTREAM Version 1-Plus Timeline for replication of databases such as Oracle.

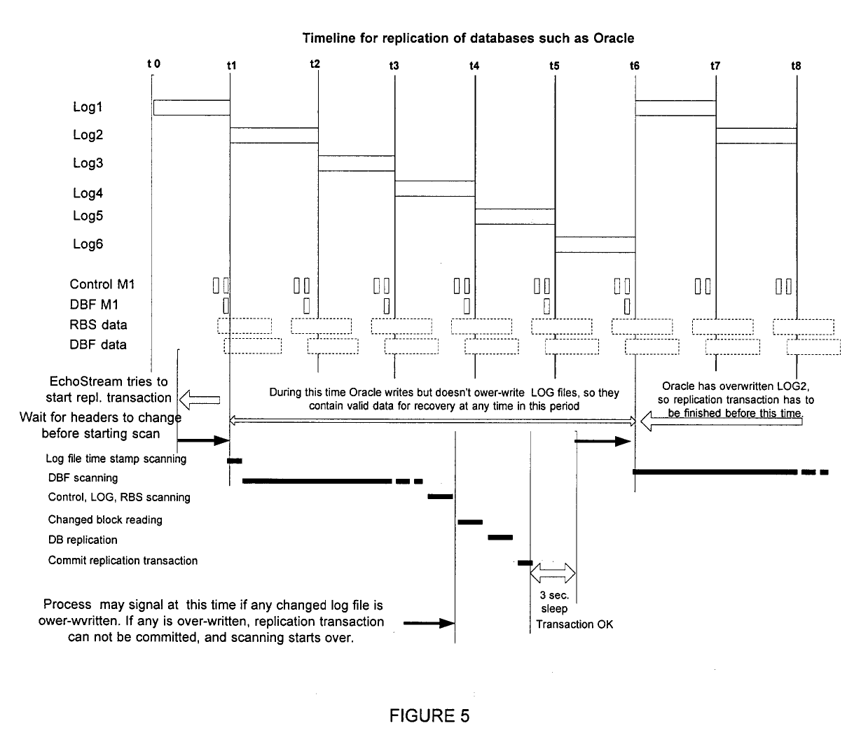

FIG. 6 is an H.A. ECHOSTREAM Version 1-Plus data flow of processes unique to H.A. ECHOSTREAM Version 1-Plus version.

FIG. 7 is an H.A. ECHOSTREAM Version 2 object-based data control flow diagram.

FIG. 8 is an H.A. ECHOSTREAM Version 2 data control flow diagram for tDBObserver object.

FIG. 9 is an H.A. ECHOSTREAM Version 2 data control flow diagram for tBlkAnalyzer object.

FIG. 10 is an H.A. ECHOSTREAM Version 2 Timeline for replication of databases such as Oracle.

### DETAILED DESCRIPTION OF THE INVENTION

This disclosure (including the background of the invention, summary of the invention, detailed description and abstract) addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims. For example, while this disclosure discusses the use of DB2 or Oracle databases, one skilled in the art will understand that other databases can also be used. This disclosure also gives certain timings (such as 200 milliseconds, or 10 seconds, or 3 seconds). One skilled in the art will recognize that such timings vary depending on the exact implementation of the invention, the speed of the hardware running the software, etc. This disclosure also discusses certain data and file sizes, such as 12-byte Block Entries in a File Control Table and 32 KB physical blocks of data. Of course, one skilled in the art will recognize that the inventions can be implemented to handle file control tables and physical blocks of data of varying sizes.

While this disclosure is directed to embodiments of the invention included as part of one of three versions of the H.A. ECHOSTREAM data replication software, one skilled in the art will understand that other embodiments of the present invention can be included in other types of software packages.

H.A. ECHOSTREAM Version 1:

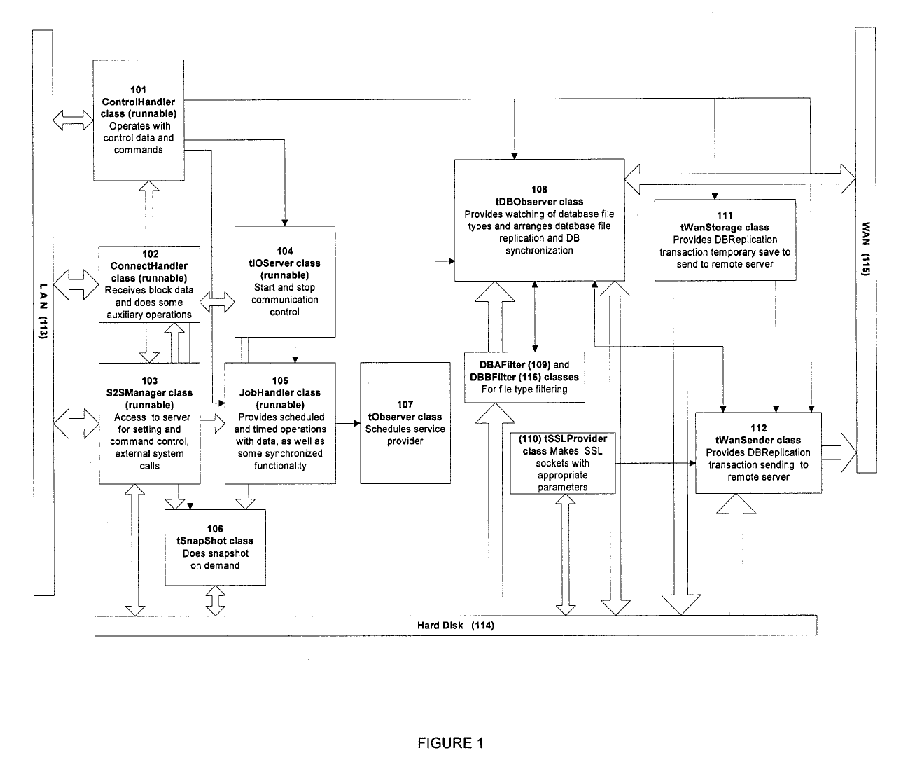

H.A. ECHOSTREAM Version 1 is a multi-thread OOD (Object-Oriented Design) software system that includes a number of objects that communicate together using data and control channels. These objects, which are shown in FIG. 1, are:

Description of H.A. ECHOSTREAM Version 1 Objects:

S2SManager class 103 arranges the main work and provides general parameters for communication between the source and destination servers.

ControlHandler class 101 is responsible for receiving and interpreting commands and data from two subjects (control agents): the GUI (directly from user) and the special auxiliary application that is used by H.A. CLUSTERS High Availability Software to control the H.A. ECHOSTREAM Data Replication Software.

tlOServer class 104 is an auxiliary object that contains a number of functions and data for input/output operations and serves other classes for that purpose. It is also responsible for receiving replication data for the destination server.

JobHandler class 105 is a dispatcher that dispatches time-dependent operations for other classes.

tObserver class 107 observes the selected directory for non-database files (like BLOB—binary large object files), which have to be replicated as-is.

tDBObserver class 108 observes the selected directory for database files that have to be replicated block-by-block.

DBAFilter 109 and DBBFilter classes 116 provide file filtering for the tDBObserver class 108.

tWanStorage class 111 provides storage to temporarily save replicated data to create the data replication transaction that will be passed to a remote destination server (using a WAN 115 connection).

tWanSender class 112 is responsible for sending data replication transactions to a remote destination server across a WAN 115 connection.

tSSLProvider class 110 provides a SecureSocketLayer interface for a WAN connection.

Description of How H.A. ECHOSTREAM Version 1 Processes Work:

When H.A. ECHOSTREAM Version 1 starts to run, the S2SManager class 103 class starts first and arranges an infinite loop to listen to the network for IO port 2224. This port provides the main command interface for the H.A. ECHOSTREAM application. After receiving any messages for control port 2224, 2SManager 103 makes a sample of the ControlHandler class 101 as a separate thread. In addition, S2SManager 103 makes a socket object for network communications and passes it to the ControlHandler class 101. When ControlHandler 101 receives the message using the given socket, it interprets the message and—depending on the message code—provides a service (e.g., sending file system information to the GUI when the “Select” button is pressed, or receiving and passing other commands and parameters for other Objects in the system; in other words, performing all necessary control actions specified by the received command).

When the “Start” command is initiated in the GUI, the ControlHandler 101 performs the following steps:

1. Make instances of the tlOServer 104 and JobHandler 105 classes and bind them to S2SManager 103.

2. Provide these objects with appropriate parameters, such as the database type and database directory.

3. Set the filtering for the different kinds of database files of the database. DBAFilter 109 is used for database files that have to be replicated block-by-block and DBBFilter 116 is used for other associated files—like BLOB (binary large object) files that have to be replicated as-is.

4. Start tlOServer 104 and JobHandler 105 class threads, if they are not started jet.

Each object, when created, does its own initialization and allows other classes to use it by using flags.

The JobHandler class 105 pushes tObserver 107 to check the selected directory every three seconds.

The tObserver class 107 by either initializes its hash table with time last modified for selected directories and files (those specified with the GUI's Select function) or loads the previously-created hash table from the file. Then, every three seconds (when demanded by JobHandler 105) it check the current state of the files in the selected directory and, if any were changed, puts the name(s) of those files in the list for replication to the destination server.

If a file was deleted, tObserver 107 puts that name in the list to be deleted from the destination server. Than it passes both lists back to JobHandler 105 and updates the hash table in file. Since that hash table is persistent, this guarantees correct update information on the destination server.

The JobHandler class 105 sends files to be replicated as specified on the list of files, or removes files from the destination server as specified in the list. To do so it creates the appropriate number of threads (one thread for each file, but not more than 15 threads at a time). Each thread performs an instance of the WriteThread auxiliary class (not shown in the drawing).

All operations to send or delete files are persistent. This means that if for some reason a sending or removing operation is not completed (e.g. due to a loose network connection, an unexpected server stop, etc.) all operations will be repeated later after reconnection or at the next server session.

tObserver also passes on commands received from the JobHandler 105 (at least once every three seconds) to the tDBObserver 108 class, which replicates database files.

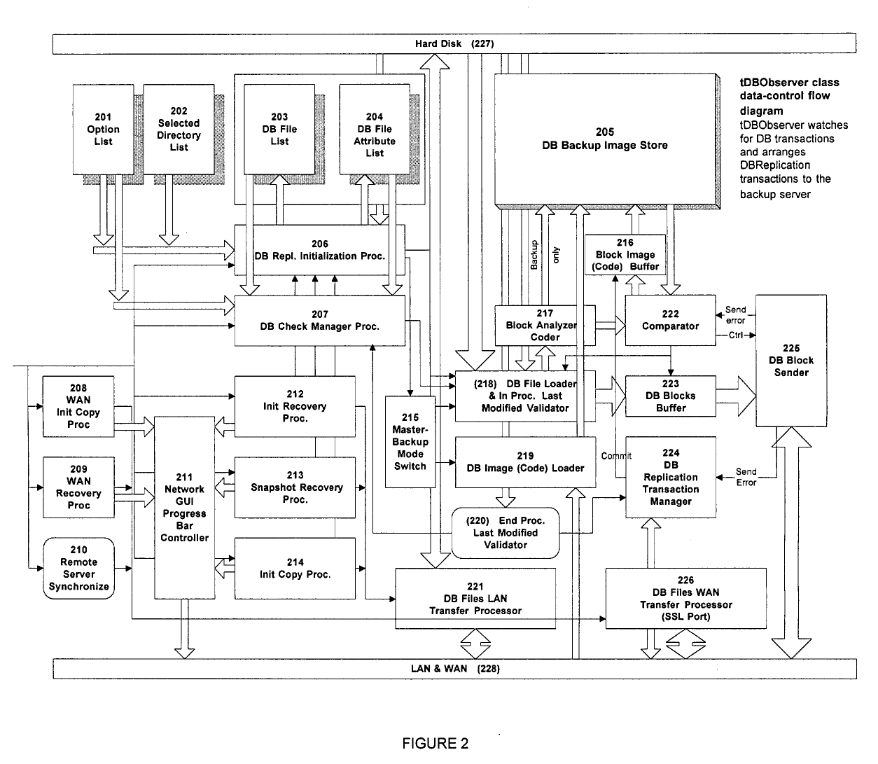

The processes performed by tDBObserver class 108 are shown in more detail in FIG. 2. Each database file is logically separated into 32 KB sequenced blocks of 32K. tDBObserver 108 scans the file and calculates values for each block (based on control sums or time stamps, depending on the database type); it then builds one table of these images for each database file. If the database overwrites a block, the database's control sum or timestamp is changed, so the block image will be changed too.

In general terms, the replication process on the source server receives the tables of block images from the destination server and compares it with same kind of tables calculated for current database files. If the process detects a difference between corresponding block images, it prepares that block of data for replication.

Each block of the diagram in FIG. 2 represents either a process (the two-dimensional, or unshaded, blocks) or data (the three-dimensional, or shaded, blocks).

All the functionality of this tDBObserver class 108 object is invoked from an entry from the outside. This entry is activated by the JobHandler class 105 at least once every three seconds. However, the object behavior for these actions may be different and depends on current job mode flags and other parameters.

The tDBObserver class 108 object handles six database replication scenarios, depending on what the customer has chosen:

1. Making an initial copy on the destination server.

2. Performing the start of the database replication process.

3. Performing regular (continuous) replication.

4. Performing the recovery process.

5. Performing a recovery from the snapshot copy.

6. Stopping data replication.

These scenarios are described below, following the next several paragraphs of introductory explanation.

Some of these operations follow each other automatically. For example, when the server starts the initial copy, it automatically goes on to perform the regular start of replication. The same is true after recovery.

In addition, the tDBObserver 108 object performs or sends to the destination server certain particular commands (e.g., scheduled or manual snapshot update) which it receives from the JobHandler class 105.

When tDBObserver 108 starts the first time or is started via the Start command received from the GUI, it first performs all initialization processes, using the DB Repl. Initialization Proc. 206 shown in FIG. 2.

The DB Repl. Initialization Proc. 206 process performs several actions:

1. It checks for and initializes the list of the options (parameters) for replication, including: full path and number of folders to replication, destination server IP address, and destination server folder (used for file name masquerading).

2. It checks the list of the files in selected folders to be replicated.

3. It checks the list of the database files in the selected folders.

4. It checks the DB file attributes—time last modified and size.

5. It performs initialization for data structures and memory allocation.

6. It checks server status and sets a switch for the server to work either in an active mode or as a backup (used for many-to-one replication).

Then, depending on the current mode specified by the customer in DB Repl. Initialization Proc. 206, the tDBObserver 108 performs one of these six scenarios:

1. Initial Copy Scenario

One embodiment of the invention includes the use of a method for initially making a backup copy of a database that can be installed, configured, and started without halting a customer database that is already in use. This method is illustrated in the initial copy scenario.

The DB Repl. Initialization proc 206 in FIG. 2 gets the regular file list of the selected directory as well as a database file list with attributes. It then starts the Initial Copy Proc. 214 process in FIG. 2 and passes it all the data. The Initial Copy 214 process sends commands with parameters to the destination server to activate some data structures that are required for the new backup copy (the path to the folder of the backup copy, and to the snapshot copy, if any, and some backup and snapshot parameters as well). It also sends a request to the GUI to show the progress bar for the initial copy process.

Then the Initial Copy 214 process send all the files from the selected directories. If the snapshot option is selected, the destination server makes two copies of each file that is sent—in the backup database folder and in the snapshot folder. After each file has been received successfully, the destination server sends an acknowledgement message to the source server, and the Initial Copy 214 process sends a message to the GUI to update the progress bar. If an error occurs, it prints an error message.

After the Initial Copy 214 process is completed, it sends a command to the GUI to hide the progress bar and branches back to the DB Repl. Initialization 206 process. If all operations were successful and the initial copy is done, the DB Repl. Initialization 206 process performs a regular start of replication.

2. Start of Replication Scenario

The start of replication is performed by the DB Repl. Initialization 206 process automatically after it receives a “Start Replication” command from the GUI, or after the “initial copy” or “recovery” processes are completed and there are no pending user requests to perform a recovery.

First of all, this process sends to the destination server a request for backup initializations and waits for the response. Simultaneously, it sends a command to the GUI to display the progress bar.

To get ready for replication, the destination server performs several operations:

1. It checks the file list for regular and backup files and send both lists to the source server.

2. It scans each of the database files to make the table of block images—called “file image.” After that process is done for each file, it send an acknowledgement message with the file name and size to the source server, which uses this information to update the progress bar.

3. After all database file are scanned and all file block image tables are completed, the destination server sends all the data to the source server.

The DB Repl. Initialization 206 process on the source server receives data from the destination server. To do so it performs the DB Image (Code) Loader 219 process in the block diagram in FIG. 2, which receives data over the LAN or WAN, parses it to the appropriate structures, and puts it to the DB Backup Image Store 205 shown in FIG. 2. This includes a table of the block images for each database file on the destination server, the time and date last modified for each database file, and the size of the file.

If all the actions are successful, DB Repl. Initialization 206 process sets a flag of “init successful” and a flag of “first transaction not done yet,” and ends.

3. Regular Replication Scenario

One embodiment of the invention includes the use of a method for database replication that is self-healing and that can recover and resume without loss of data even if the replication process is slowed, interrupted, or halted. The regular replication scenario illustrates this method.

The regular replication scenario performs if the Initial Copy is complete and there are no pending user requests to perform a recovery. If these conditions are not met, the DB Repl. Initialization 206 process can't start; and the DB Check Manager 207 process shown in FIG. 2 performs instead. This process provides regulation to ensure the replication process is working.

If regular replication is ready to begin, tDBObserver 108 performs the following steps:

1. It loads database files consecutively, using the DB File Loader& In Proc.Last Modified Validator 218 process.

2. It scan the blocks and calculates a block image, using the Block Analyzer—Coder 217 process.

3. It compares the current block image with the appropriate block image from the backup (stored in DB Backup Image Store 205), using the Comparator 222 process.

4. If the blocks are different, it puts the block image in the block image buffer and puts the block copy out to the buffer to replication, using the Comparator 222 process.

5. After the entire database data (.DBF) file is scanned, it checks the last modified time of the file. If the file was modified during the scan, blocks of data may be invalid, so discard all blocks from the buffers and scan the file again, using the DB File Loader& In Proc. Last Modified Validator 281 process.

6. After all data in the file is scanned, it checks at the end of the process to see if any database data (.DBF) files (but not .LOG files) were modified; if so, the data may be invalid so it scans all database files again, using the End Proc. Last Modified Validator 220 process. (It should be noted that these two double-check actions can restrict replication speed on large databases; H.A. ECHOSTREAM Version 1-Plus and 2 each have other methods for providing greater speed on large databases.)

After the Comparator 222 process has finished its work and all files have been scanned successfully without modification, it pushes the DB Blocks Buffer 223 process to pass the data to the DB Block Sender 225 process.

The DB Block Sender 225 sends all modified blocks with appropriate auxiliary information to the destination server. Immediately after the data is sent to the destination server and if there are no errors, the DB Replication Transaction Manager 224 process sends a request to the destination server to ask if all the operations were done successfully and waits for a response.

When data with changed blocks is sent to the destination server, it saves it in a temporary file on disk. If something is wrong with it (e.g., an error writing the file after successfully receiving the file), it sets an error flag. When the destination server receives an acknowledgement request from the source server, the destination server checks the error flag and returns an error immediately if the error flag is up. If there is no error, the destination server updates the destination server's database file blocks with the data received from the temporary files, and returns a “no error” value to the source server.

The DB Replication Transaction Manager 224 checks the response. If any error occurs (it does no matter whether it occurs on the source or the destination side), it discards any data both from the Block Image (Code) Buffer 216 and from the DB Blocks Buffer 223, and ends the tDBObserver 108 work session with a transaction error.

The tDBObserver 108 process waits until JobHandler 105 pushes it again in the next three second. If there is no error, it means that the data replication transaction was successful, so it updates the DB Backup Image Store 205 tables with current values from the Block Image (Code) Buffer 216, then discards the DB Blocks Buffer 223 and ends successfully, and waits until the JobHandler 105 process pushes it again in the next three seconds.

One embodiment of the invention includes the use of a method for making database snapshots that creates and maintains snapshots of a database at periodic, customer-specified intervals without negatively impacting performance on a source server. The use of this method is illustrated by what happens when the snapshot option is on.

If the snapshot option is on, DB Check Manager 207 process also checks the flag for snapshot update. This flag is controlled by JobHandler 105, which sets it up if it is a scheduled snapshot time. If it is a scheduled snapshot time, DB Replication Transaction Manager 224 sends a snapshot request to the destination server together with a transaction acknowledgement request.

The destination server then updates the snapshot database from the backup database, using the list of numbers of changed blocks it collected earlier while processing data replication transactions prior to updating the backup database. This allows it to performs all snapshot operations locally on the destination server.

4. Recovery Scenario

If a recovery command was received from the GUI, the next time the tDBObserver 108 class is pushed by the JobHandler 105, it performs the DB Repl. Initialization 206 process for recovery. To do, so it sends a request to the destination server to get all the files that it has in the backup directory; when it receives the list of files from the destination server, it pulls all of the files from the destination server.

After that process is done, it automatically starts the initialization process to synchronize data and start replication, using the Init Recovery Proc. 212 process.

5. Recovery from Snapshot Scenario

This scenario does almost the same as described above for the recovery scenario, except that the destination server performs a copy from the snapshot copy to the backup copy before it returns the list of files, so the server can perform the recovery process using snapshot data. The Snapshot Recovery proc. Process is used for this.

6. Stop Replication Scenario

To perform the stop replication process, the ControlHandler 101 process sets a flag to stop. The JobHandler 105 and other running threads check this flag and stop in a proper manner. However, some important processes that must operate on urgent jobs ignore this stop flag until they can stop without risk.

The destination server implementation uses the same set of objects described above, because each server may serve either as the source or destination, depending on the configuration specified in the GUI or in the H.A. CLUSTERS High Availability Software script.

The destination server does not start the JobHandler class 105; as a result, it never starts any process from the tObserver 107 or tDBObserver 108 classes.

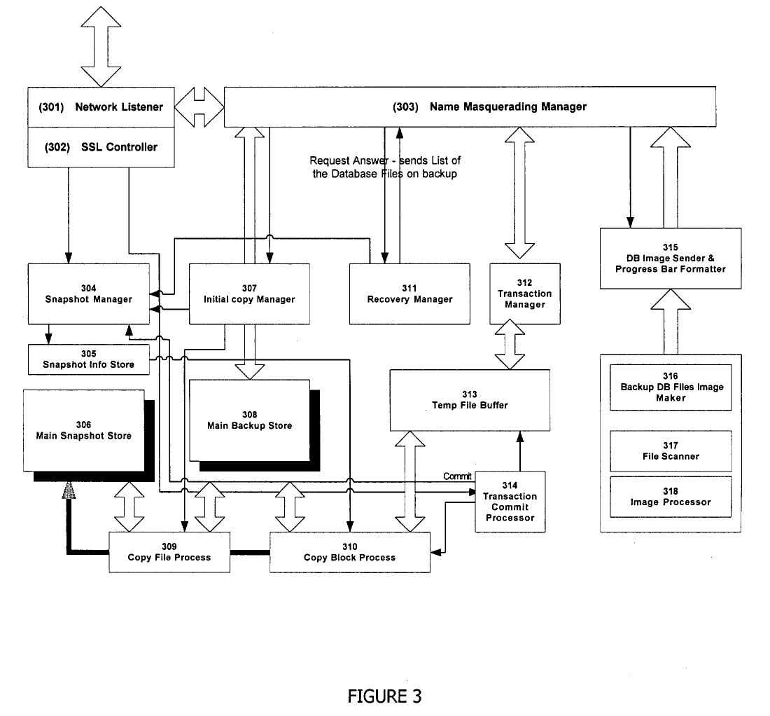

On the other hand, three classes that are passive on the source server—tlOServer class 104, ConnectHandler class 102, and tSnapShot class 106—are used to perform most of the jobs for the destination server. The processes performed by these three objects are shown in FIG. 3.

When the destination server receives a start command, its ControlHandler class 101 process starts the work thread of the tlOServer class 104. This thread performs an infinite loop to listen on the network for port 2222. All the work messages and data use that port to communicate between servers. SSL property optionally may to be added to the tlOServer 104 listener (Network Listener 301). If any message or data comes in, the tlOServer 104 listener makes a socket for network connections and passes it to the ConnectHandler 102 thread, which receives data using the Name Masquerading Manager 303. The Name Masquerading Manager 303 makes it possible to have several backup databases for several source servers on one destination server by using naming conventions to uniquely identify each source server's files. This process also dispatches data depending on the destination process that is specified in the header of each message, as explained below:

a. If the destination field in the message header is “initial copy,” the ControlHandler 101 branches to the Initial Copy Manager 307, which receives the data file from the network and writes it to the disk, to Main Backup Store 308. It also extracts from the message important attributes of file which are sent together with data—permissions, owner, groups for the file and the original time last modified, and assign it to the file. If the snapshot option is turned on, the Initial Copy Manager 307 also copies the database to the snapshot folder—to Main Snapshot Store 306.

b. If a request is received from the source server to perform a regular start of replication, the ConnectHandler class 102 object, with the Name Masquerading Manager 303 process, activates DB Image Maker & Progress Bar Formatter 315 process, which perform several steps:

1. It checks the file list for regular database (e.g., .DBF) and backup (e.g., BLOB) files.

2. It scans each of the database files to make a table of block images for the file. The DB Image Maker & Progress Bar Formatter 315 process sends all necessary information to the progress bar on the GUI on the source server.

3. It sends all database “file images” in the specified format to the source server, together with the entire list of all database and regular files along with attributes and some auxiliary information.

c. If a request is received from the source server to perform regular replication (i.e., data is received that needs to be replicated), the ConnectHandler 102 class with help from the Name Masquerading Manager 303 starts the Transaction Commit Processor 314, which receives data (changed blocks) and puts it into a temporary file on the disk.

After a transaction acknowledgement request is received for the transaction commit, the listener makes the ConnectHandler 102 thread process this message and commit the transaction. The ConnectHandler 102 thread starts the Transaction Commit Processor 314, which first checks whether the snapshot update request has been received. If the request has been received, the Transaction Commit Processor 314 passes the command to update the snapshot copy to the Snapshot Manager 304 process from tSnapShot 106 (see FIGS. 1 and 3). The Snapshot Manager 304 checks the list of changed blocks (this is a list of the numbers of the changed blocks) and copies all the specified blocks from the backup database to the snapshot database, using the Copy Block 310 and Copy File 309 processes of tlOServer 104 (see FIGS. 1 and 3).

If the snapshot copy was successful, Snapshot Manager 304 updates the appropriate info structures inside the tSnapShot 106 object. If there was no snapshot update request (these can come in on-demand or on a scheduled basis), it extracts blocks with auxiliary information from temporary files and updates database files on the destination server. Simultaneously, if the snapshot option is on, the Snapshot Manager 304 puts all the numbers of the received blocks in the list of changed blocks for snapshot; this list will then be used by the next snapshot updating action.

If the process to update blocks is successful, the Transaction Commit Processor 314 returns a “no error” message to the source server, after which the transaction is done and committed. If there is an error, it returns an error message to the source server.

d. If a request is received from the source server to perform a recovery, the Connect Handler 102 thread branches to the Recovery Manager process, which makes a list of all files in the appropriate folders on the destination server and returns it to the source server. The source server then uses the information to perform a recovery.

e. If a request is received from the source server to perform a recovery from the snapshot copy, the Recovery Manager 311 process first of all passes command to the Snapshot Manager 304 to copy the snapshot database to the backup database, then checks the files and sends the backup list to the source server. The source server then uses the information to perform a recovery.

Thus, all the functionality of the destination server is passive.

One embodiment of the invention is a method of replicating to a single destination server changes to databases housed on a plurality of source servers. To accomplish this, a plurality of locations is specified on the destination server, where each of the locations corresponds to one of the source servers. This specification includes detailed information about the location on the source server and the IP address of the source server, so the destination server always knows the appropriate location in the event a database recovery is necessary. In addition, specification information is stored on each source server, so each source server knows where on the destination server to replicate the source database. When a source server sends a file to the destination server, the Name Masquerading Manager 303 process (see FIG. 3) uniquely identifies that file so the destination server knows which source server is sending the file. For example, suppose there are three source servers and each stores its own database in a directory with the same name, called “/opt/u02/”. Suppose further that, on the destination server the user assigns the directory “/client10738/” (where the first digit of the number indicates the server and the last four digits are a security code) to the first server, “/client20567/” to the second server, and “/client30844/” to the third server. When the first source server sends a database file to the destination server, it prefixes “/client10738/opt/u02/” to the beginning of the file name, using information provided by the Name Masquerading Manager 303 process on the destination server. In the same fashion, the second server prefixes “/client20567/opt/u02/” to the file name and the third server prefixes “/client30844/opt/u02/” to the file name. In addition, each source server appends to the beginning of each database file it sends to the destination server a plurality of control information that is unique to each source server, such as the size of blocks used, the type of database used, and whether a snapshot copy of the database should be maintained.

Furthermore, replication from a plurality of source databases to a single destination server is accomplished by providing a plurality of processing threads on the destination server, each of which is unique to each source server. When the replication process on each source server communicates with the destination server, it communicates with the processing thread that is dedicated to servicing that source server. Thus, each source server's replication needs are handled separately on the destination server.

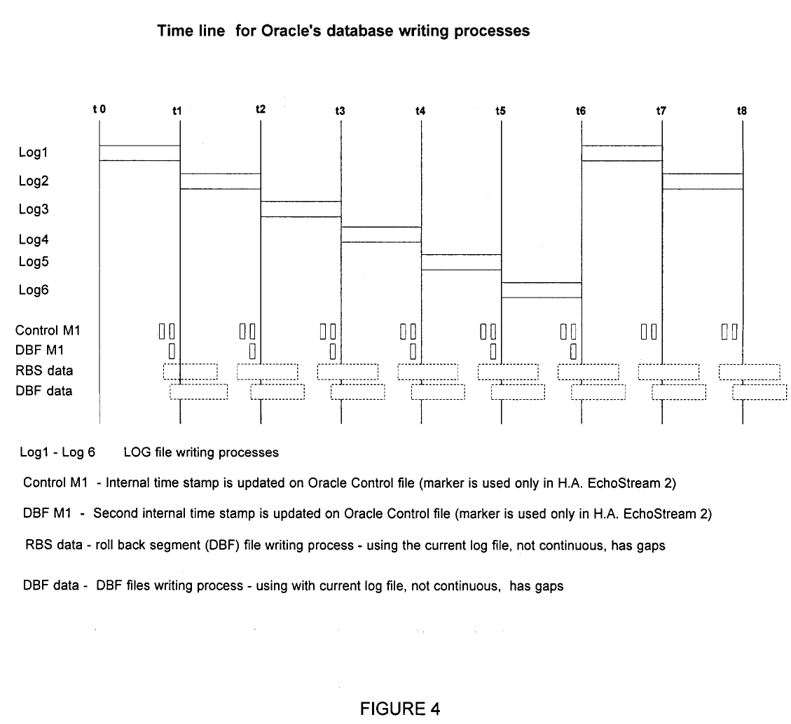

FIG. 4 illustrates Oracle's time-dependent actions. H.A. ECHOSTREAM Version 1 replicates asynchronously, so it does not make use of any of Oracle's time stamp or marker information. However, H.A. ECHOSTREAM Version 1-Plus and H.A. ECHOSTREAM Version 2 each use Oracle time stamp and marker information in unique ways, as explained below.

H.A. ECHOSTREAM Version 1-Plus:

One embodiment of the invention includes the use of a method of scanning a database for changes to be replicated that reduces the impact of rescanning on system performance. The use of this method is a unique feature of H.A. ECHOSTREAM Version 1-Plus, as explained below.

H.A. ECHOSTREAM Version 1-Plus inherits all of the H.A. ECHOSTREAM1 object shown in FIG. 1. However, some of the functionality for the tDBObserver 108 object is a bit different.

The most significant difference in terms of functionality is that H.A. ECHOSTREAM Version 1-Plus does not rescan changes to database data (.DBF) files if it discovers that database transaction log (.LOG) files have been updated since the start of the current data replication transaction, unless more than two database transaction log (.LOG) files have been updated. Instead, it goes ahead and replicates the changes to the database data (.DBF) files it has already identified. It does so because, while the presence of log file changes made since the start of the current data replication transaction indicates the database has recorded new changes that are not reflected in the already-scanned changes H.A. ECHOSTREAM has collected, the database itself has the built-in capability to recover those changes from the two most-recent log files if the database crashes at this point, as long as the log files themselves are replicated to the destination server. As a result, H.A. ECHOSTREAM Version 1-Plus can work with more-frequently-updated databases. (Note that this performance improvement applies only to the regular replication scenario.)

Like H.A. ECHOSTREAM Version 1, H.A. ECHOSTREAM Version 1-Plus can determine if a file was changed either by checking the last modified time value (it does this most of the time) or by checking the time stamp in the header (this method is needed when Oracle is running under Windows because Oracle under Windows does not change the last modified time for its database files when it updates the files.)

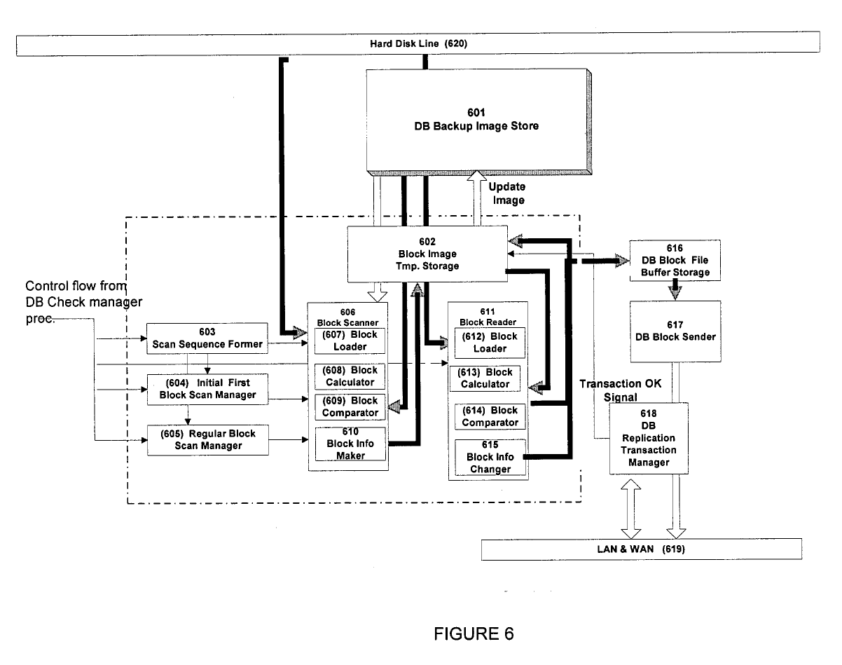

With this new approach, several processes in the tDBObserver 108 class were changed. The changes affect the processes shown in FIG. 2. The DB File Loader & In Proc. Last Modified Validator 218, Block Analyzer-Coder 217, Comparator 222, End Proc. Last Modified Validator 220, and Block Image (Code) Buffer 216 processes were changed. The replacement processes are shown in FIG. 6, which represents the mechanisms for scanning and watching changed blocks in H.A. ECHOSTREAM Version 1-Plus.

As shown in FIGS. 1, 2, and 6, when common control flow branches to the DB Check Manager 207 process for each tDBObserver 108 object session (not longer than three seconds), it starts three sub-processes sequentially:

1. The Scan Sequence Former 603 process provides the scan order used in H.A. ECHOSTREAM Version 1-Plus; namely: scan control files, then database data (.DBF) files, and then log (.LOG) files.

2. The Initial First Block Scan Manager 604 process makes and processes the first block image of each file, so it can determine (from the timestamp of the header of the block) if the file was overwritten. This is especially important when running under windows, since the Oracle database does not change the file time and date stamp.

3. The Regular Block Scan Manager 605 process causes the block loader to load blocks consequently. It also reloads the first block of the file again after the file is scanned, because some database processes may update that block at the end of write session.

Unlike H.A. ECHOSTREAM Version 1, H.A. ECHOSTREAM Version 1-Plus has two conveyers to load and compare blocks—one operates during file scanning, while the other operates to double-check that the database has finished changing the block that was previously selected as changed. They operate in the way described below (and illustrated in FIGS. 1, 2, and 6):

The first conveyer, Block Scanner 606, is controlled by the Initial First Block Scan Manager 604 process and by the Regular Block Scan Manager 605 process. First it performs a block loader step to load current block from the data base file. In the next step, the block image is calculated, then the Comparator 222 loads the old block image from the DB Backup Image Store 205 (which is now a local table in memory) and compares it with calculated one. If there is no difference, the process goes ahead. If there are any differences between the two images, the Block Scanner 606 conveyor first copies the block to a DB Block File Buffer Storage 616 (like H.A. ECHOSTREAM Version 1) and puts the block image with some attributes (i.e., block size and block number) to the Block Image Tmp. Storage 602.

After the scanning process for a given file is finished, the DB Check Manager 207 process starts the second conveyer, Block Reader 611, which checks all the blocks in the Block File Tmp. Storage 602 and compares them with blocks reloaded from the file. If it can see any difference, the Block Reader 611 conveyer updates information in the DB Block File Buffer Storage 616 and in the Block Image Tmp. Storage 602 for a given block. This situation shows that the database is still writing to the block. The DB Check Manager 207 process repeats that operation with the second conveyer until no differences are found. This approach prevents the block splitting problem.

After all files in the database are scanned, the DB Check Manager 207 process checks if more than two log files (for Oracle) (except for the current log file), are modified. If they have not, it goes ahead with data replication, like H.A. ECHOSTREAM Version 1. If more than two log files have been modified (besides the current log file), this means that the database has started another log file to write to. In this case, the DB Check Manager 207 discards the DB Block File Buffer Storage 616 and the Block Image Tmp. Storage 602 and the DB Check Manager 207 process ends with this error “no enough time”, and in the next three seconds, tDBObserver 108 will perform its next session.

See FIG. 4 for further illustration of how H.A. ECHOSTREAM Version 1-Plus coordinates its replication efforts with Oracle's time-dependent actions, including when it checks to see whether more than two database log (.LOG) files have been updated.

All other functionality is the same as for the H.A. ECHOSTREAM Version 1 process.

H.A. ECHOSTREAM Version 2:

One embodiment of the invention is the use of a method for scanning a database for changes to be replicated that speeds up the process for large databases. The use of this method is a unique feature of H.A. ECHOSTREAM Version 2, as explained below.

H.A. ECHOSTREAM Version 2 inherits the functionality of H.A. ECHOSTREAM 1 and 1-Plus, but provides additional advanced functionality.

Most importantly, H.A. ECHOSTREAM Version 2 does not scan database data (.DBF) files to see what blocks have changed while regular (continuous) replication is running. Instead, it scans only the current database log (.LOG) file only (since it is relatively small) and extracts information about database blocks that have to be replicated. However, the existing scanning mechanism from H.A. ECHOSTREAM Version 1 and 1-Plus (wherein all files are scanned), is retained during initial processing to synchronize data between the source and destination servers immediately after starting data replication.

This process of scanning only the current database log (.LOG) file during regular replication is used because it works with larger and very busy databases. It has been tested up to approximately 500-600 write transactions per second and on databases with up to 7 GB of updated data per hour.

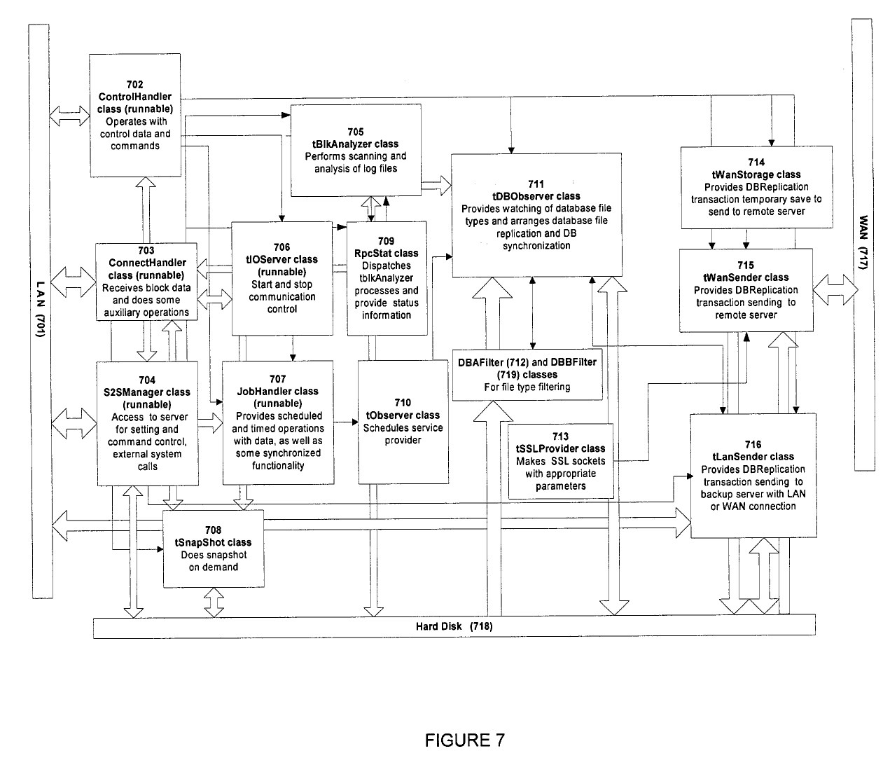

To provide this functionality for larger and very busy databases, three new classes were added to the base H.A. ECHOSTREAM Version 1 and 1-Plus products; these class objects are shown in FIG. 7:

1. tBlkAnalyzer class 705 does all of the necessary work to obtain data block ID numbers for the blocks that need to be replicated.

2. tLanSender class 716 provides an enhanced mechanism to send replication data from the source server to the destination server.

3. RpcStat class 709 dispatches a database log (.LOG) file scanning process that watches the replication process state and sends messages to the GUI and to the H.A. ECHOSTREAM log file.

These process differences affect two of the six data replication scenarios described earlier, the tart of replication scenario and the regular replication scenario. The differences in these two scenarios is described below:

Start of Replication Scenario

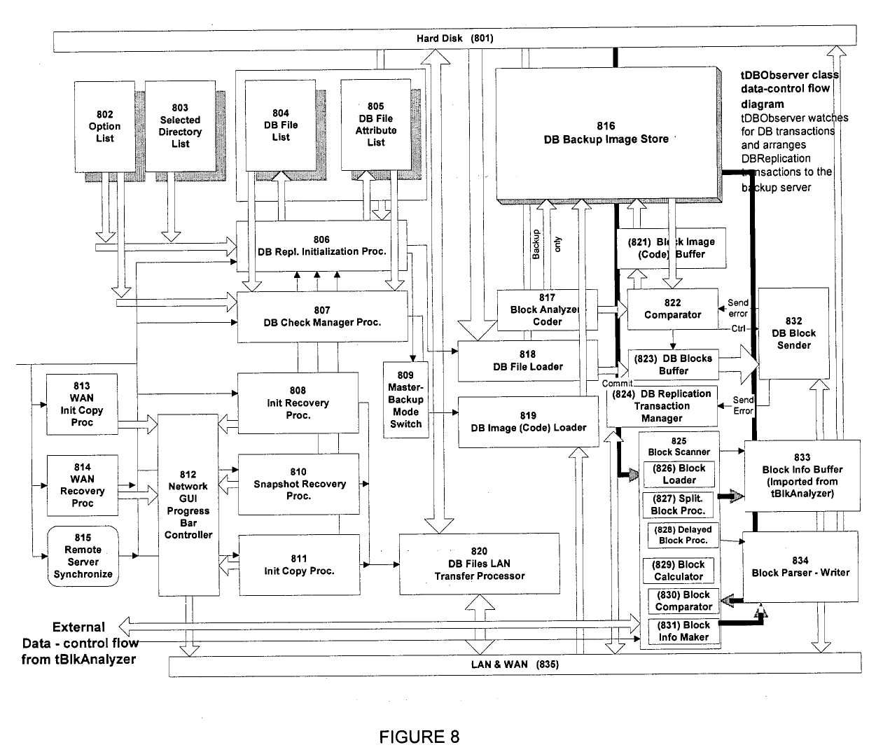

The start of replication is performed by the DB Repl. Initialization Process 806 automatically (see FIG. 8) after it receives a “Start Replication” command from the GUI, or after the “initial copy” or “recovery” processes are completed and there are no pending user requests to perform a recovery.

The initialization process for H.A. ECHOSTREAM Version 2 is more complicated than for H.A. ECHOSTREAM Version 1 or 1-Plus. As shown in FIG. 7, the tDBObserver 711 object starts initialization processes on tBlkAnalyzer 705 to determine, for Oracle as an example, the set of the database log (.LOG) files and database data (.DBF) files, their names and ID in the database context, the database block size, the block range for each database file, etc.

The initialization process performed by tBlkAnalyzer 705 for Oracle (for example) includes the following steps:

1. Create and initialize all data structures.

2. Make a list of all database data (.DBF) and database log (.LOG) files with attributes (file name, Oracle file ID, size, and time), using Oracle database information.

3. Check the byte order for the hardware platform (Big or Little Endian).

4. Determine the block size used by the Oracle database.

5. Scan all Oracle log files and store information about each log file in DB Backup Image Store 816.

During this initialization process, tDBObserver 711 sets the “log file scanning process is denied” flag, so that other tBlkAnalyzer 705 processes do not operate at this time.

At the same time as tBlkAnalyzer 705 is running, the DB Repl. Initialization Process 806 shown in FIG. 8 sends a request to the destination server to perform certain initialization tasks, and then waits for a response. Simultaneously, it sends a command to the GUI to display a progress bar for the start of the replication process.

During this initialization process, the destination server performs these operations in sequence; the third step is unique to H.A. ECHOSTREAM Version 2:

1. It checks the file list for regular database (i.e., .DBF, LOG, etc.) files and backup (e.g. BLOB) files and sends both lists to the source server.

2. It scans each of the database files to create a table of block images, called the “file image”, for each file. After that process is done for each file, it send an acknowledgement message with the file name and size to the source server, which uses this information to update the progress bar.

3. In additional to the H.A. ECHOSTREAM Version 1 startup processes, H.A. ECHOSTREAM Version 2 checks the time stamp in the control file header and saves it. This action helps to identify and prevent a database crash in case the backup database is unexpectedly and inadvertently started by the customer without first stopping the replication process.

4. After all database files are scanned and all “file images” are completed, the destination server send all the data to the source server.

The DB Repl. Initialization Process 806 on the source server receives data from the destination server. To do so, it performs the DB Image (Code) Loader Process 819 shown in FIG. 8, which receives data over the LAN or WAN, parses it to the appropriate structures, and put it to the DB Backup Image Store 816. This data consists of:

1. A table of the block images for each database file on the destination server.

2. The time last modified for each database file.

3. The size of each file.

If all the actions are successful, the DB Repl. Initialization Process 806 sets an “init successful” flag and a “first transaction not done yet” flag and ends.

Regular Replication Scenario

The regular replication scenario for H.A. ECHOSTREAM Version 2 differs significantly from the H.A. ECHOSTREAM Version 1 and 1-Plus scenario. For H.A. ECHOSTREAM Version 2, it is divided into two stages. The first stage last until the first database replication transaction is finished. The second stage of the regular replication scenario lasts as long as the replication process.

The aim of the first stage (the “first database replication transaction”) is to synchronize the backup database files on the destination server with the current working database on the source server. Two objects shown in FIG. 7 accomplish this: tBlkAnalyzer 705 and tDBObserver 711, of the two, tDBObserver 711 is still the dominant object.

After the first database replication transaction is done, tDBObserver 711 sets a “first transaction is done” flag, which denies access to tDBObserver 711 from tObserver 710 unless other control information appears. (Control information would change if the customer pressed “Recovery” during the first database transaction, and this action would, in effect, suspend that first database transaction.)

This flag is set to enable tBlkAnalyzer 705 to use some of the functionalities of tObserver 710 without calling the DB Check Manager Proc. 807 process and to prevent tDBObserver 711 from scanning database data (.DBF) files.

During the first stage of the regular replication scenario, the DB Check Manager Process 807 performs the same tasks as it does for H.A. ECHOSTREAM Version 1 and 1-Plus with one exception: it does not take care of split blocks (where Oracle updates parts of the same block at different times) since the dual tBlkAnalyzer 705/tDBObserver 711 objects (explained below) take care of this in the second stage in H.A. ECHOSTREAM Version 2.

The DBCheck Manager Process does this because it works asynchronously with Oracle, but knows if any block is modified by Oracle during the second stage of the regular replication scenario and replicates the block. If a split block occurs (where Oracle updates the block again after it's been replicated), the tBlkAnalyzer 705 will detect and replicate the second change to that same block. (In other words, in H.A. ECHOSTREAM Version 2 split blocks are replicated twice, first by tDBObserver 711 and then by tBlkAnalyzer 705.)

Before the DB Check Manager Proc. 807 process start database file scanning on the source server, it gives permission to the tBlkAnalyzer 705 class to start scanning the current log and collecting blocks that are being changed by Oracle.

With H.A. ECHOSTREAM Version 2, database synchronization is distributed to two objects. The tDBObserver 711 object is responsible for synchronizing all blocks that were changed before tBlkAnalyzer 705 was started, while tBlkAnalyzer 705 is responsible for synchronizing all block that are modified by Oracle after it (tBlkAnalyzer 705) starts. The use of these two classes guarantees correct synchronization of database files after the start replication even if database is running during this time and is therefore updating log files at the same time as they are being scanned by H.A. ECHOSTREAM.

After the first transaction is done, most of the tDBObserver 711 process is not used unless the customer initiates a “Recovery”. However, part of tDBObserver 711, called from the tBlkAnalyzer 705 process, is used, as shown in FIG. 8.

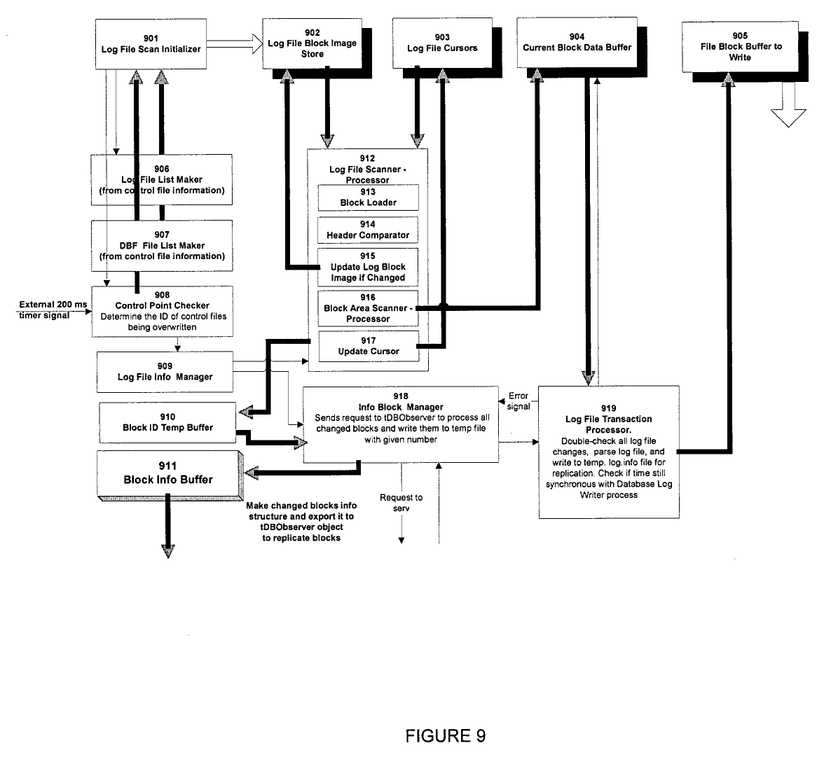

During the second stage of the regular replication scenario, tBlkAnalyzer 705 works synchronously with the database (e.g., Oracle). The tBlkAnalyzer 705 object determines which Oracle log file is currently active and scans header blocks of the log file to get information on which blocks have been updated by the Oracle Log Writer. This is shown in more detail in FIG. 9.

During the first stage of the regular replication scenario, tBlkAnalyzer 705 is active but is not allowed to write any replication information to disk, since the first stage operates with full scanning and may take a long time; instead, during the first stage, tBlkAnalyzer 705 just collects information about blocks that need to be written to disk. (How it finishes this process is explained below.

Every 200 milliseconds, tBlkAnalyzer 705 receives a message from the RpcStat 709 object to start a scan session. At this time, the Control Point Checker 908 process in FIG. 9 starts to determine which Oracle database log (.LOG) file is current for database at the present time, which log files were updated since the last session (if any), and if any Oracle control point was reached, thereby switching the current log file.

Then the Log File Scanner Processor 912 process starts to scan all log files that were updated. Usually there is only file—the Oracle current log; occasionally there are two if Oracle just changed log files.

A special cursor mechanism is used for this scanning process. TBlkAnalyzer 705 has a table of cursors (a start and end pair for each log file) which it uses to determine which portion of the log file has already been scanned. It only scans the portion of the log file, starting from the “start” cursor that was set during the previous scan. (The first time a log file is changed, the cursor is set to zero to start at the beginning of the file) When tBlkAnalyzer 705 scans, it first checks the header block of the log file to obtain the time stamp and compare it with the corresponding value from the Log File Block Image Store 902.

If the log file block was updated, tBlkAnalyzer 705 scans the block body to extract the ID for the data and updates the file blocks that have been changed by Oracle. All the extracted information (block and file IDs) are put to the Block ID Temp Buffer 910 in sorted, non-duplicated manner (that is, any given block only appears once in the buffer). Because this information is very compact, tBlkAnalyzer 705 keeps it in memory.

Then it processes the next log file block in the same manner and continues this process until it sees that the next scanned block has not been changed by Oracle (in that case, the block image is the same as in Log File Block Image Storage 902, with the old time stamp). When it encounters this situation, tBlkAnalyzer 705 sets the “end cursor” to the last modified block (it may be the end of the file), so tBlkAnalyzer 705 knows which area of the log file was modified now and has to be replicated.

After the scan session is completed, the Log File Info Manager 909 checks for three different situations:

A. The regular scan process was completed and no control point or log file switching occurred. In this case, the Log File Info Manager 909 just sends an informational message and ends, until the next session.

B. The control point was passed or the log file was switched because it was full. In this case, H.A. ECHOSTREAM needs to start a data replication transaction, so the Log File Info Manager 909 performs these steps:

1. It starts the Info Block Manager 918 process, which takes block ID information from the Block ID Temp Buffer 910 and puts it to the Block Info Buffer 911 along with some auxiliary information (this information is used to double-check if the block was split or if there was a delay write for that block.

2. Next, it exports each file to the Block Info Buffer 911 with a command to process, parses it, and writes it to the Block Scanner 825 process within tDBObserver 711. Block Scanner 825 searches the data file for blocks listed in the given buffer, performs a process check, fixes split blocks, and checks for and processes delayed block flags; if the block was really modified, it parses the block into the file buffer with auxiliary information for replication. Then the Block Scanner 825 process updates appropriate DB Backup Image Store 816 data, but does not remove the block from the given Block Info Buffer 911, in case there is a possible delay on Oracle's part in writing that block. When Block Scanner is finished, it renames the file in the temp data folder, using a special naming format, so that it is only then recognized by the tLanSender 716 object.

The Block Scanner 825 process also provides for delayed block writes that have still not been changed by Oracle by checking any pending blocks (blocks marked as changed in the log file but not yet written to the database) several times, and also checks blocks several times after they have been written to the database.

3. After these steps are completed, the Log File Info Manager 909 starts the Log File Transaction Processor 919, which double-checks that all log files that were changed have been taken into account; then it parses all log files and writes then to the temp log folder using a special naming format so it is only recognized by the next process when all work is finished.

The Log File Transaction Processor 919 also checks the time to see if it still can work synchronously with the Database Log Writer process. If the database has a new check point or switches to another log file before that process is completed, it means that the database is currently working faster than H.A. ECHOSTREAM Version 2 can run (it has been tested for 500-600 transactions per second and for approximately 7 GB per hour), so the Log File Transaction Processor 919 returns a time overflow error. When a time overflow error occurs, the Log File Info Manager 909 ends, and tries to fix situation during its next session. Usually, this is just a temporary problem and H.A. ECHOSTREAM Version 2 can fix it automatically during a subsequent session.

4. If no error occurs, the Log File Info Manager 909 renames the parsed temporary database file in the local temp data directory, using a “number.dat” format, and renames the parsed temporary log file in the local temp log directory in the same manner. After the files have been renamed, they are recognized by the tLanSender 716 object, which can operate with them to replicate them. The Log File Info Manager 909 assigns file numbers sequentially. This approach, together with the tLanSender 716 process and the receiving process on the destination server, guarantees that data will be replicated in the proper order. After that, the Log File Info Manager 909 ends with no error.

C. The regular scan process completed but the database does not update information for about 10 seconds.

This indicates that the database is working slowly and H.A. ECHOSTREAM has a chance to replicate a portion of the log file (even if only one database transaction has occurred). In this case H.A. ECHOSTREAM performs a data replication transaction as described above, with a special attribute indicating that no control point was reached and no log file switching occurred.

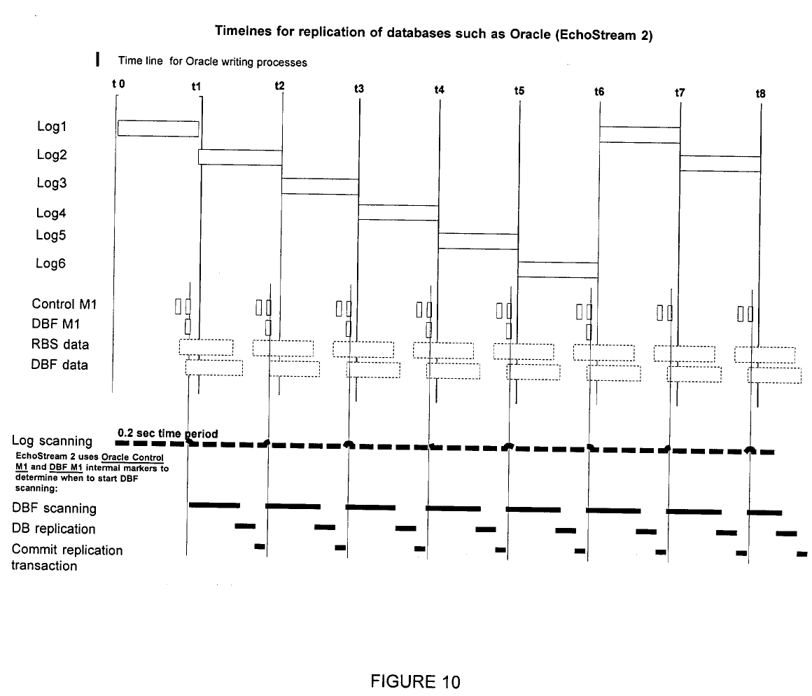

See FIG. 10 for further illustration of how H.A. ECHOSTREAM Version 2 coordinates its replication efforts with Oracle's time-dependent actions, including its use of internal Oracle markers to control when it should begin scanning of database data (.DBF) files.

What is claimed is:

1. A method for database replication that is self-healing and that can recover and resume without loss of data even if the replication process is slowed, interrupted, or halted, the method comprising:
providing replication to a destination server of a database comprising a plurality of files, wherein the files comprise database data files, database transaction log files, database control files, and various regular non-database files associated with the database;
maintaining a Master Control Table and a plurality of File Control Tables for tracking the status of the blocks of data in the plurality of files in the database; and
performing continuous, multi-threaded scanning of the database data files and database transaction log files, checking for updates.

2. A method for initially making a backup copy of a database that can be installed, configured, and started without halting a customer database that is already in use, the method comprising:
performing a copy of a database;
tracking and logging database updates being made by a customer to a source database while a replication process is performing a copy of the database; and
replicating to a destination server the tracked and logged database updates after the step of performing a copy of the database is completed.

3. A method for making database snapshots that creates and maintains snapshots of a database at periodic, customer-specified intervals without negatively impacting performance on a source server, the method comprising:
generating a complete first snapshot copy of a database;
creating a log file containing pointers to the number of blocks of data changed since the first snapshot copy was created; and
building a second snapshot copy;
wherein the step of building the second snapshot copy comprises starting with the first snapshot copy; scanning the log file; retrieving blocks of data changed since the first snapshot copy was created; and updating the first snapshot copy.

4. A method of replicating to a single destination server changes to source databases housed on a plurality of source servers, the method comprising:
specifying a plurality of locations on a destination server, wherein each of the locations corresponds to one of the plurality of source servers; and
replicating the plurality of source databases, where each source database is replicated using a processing thread unique to each server combined with a name masquerading technique that identifies to the destination server a source and location of each database file.

5. A method of scanning a database for changes to be replicated that reduces the impact of rescanning on system performance, the method comprising:
using recovery capability functionality built into a commercial database that allows the database to perform recovery using a limited number of database transaction log files provided the log files have not been updated with subsequent transactions;
temporarily suspending the rescanning of database data files when additional updates are detected in order to check the number of database transaction log files that have been updated since the start of the data replication transaction; and
resuming the rescanning of database data files only when the number of updated database transaction log files exceeds the number that the database can use by itself for automatic database updates.

6. A method for scanning a database for changes to be replicated that speeds up the process for large databases, wherein a large database has a plurality of relatively small database transaction log files and a plurality of relatively large database data files, the method comprising:
regularly scanning and replicating the plurality of relatively small database transaction log files;
scanning a plurality of header blocks on the plurality of relatively small database transaction log files to determine whether the remainder of each relatively small database transaction log file needs to be scanned;
limiting the rescanning of database transaction log files by maintaining a plurality of pointers indicating what portion of each file has already been scanned on a previous pass; and
scanning one of the relatively large database data files only when a change is discovered for said file;
wherein the change is discovered using data on database transaction log files that point to corresponding changes made to particular database data files.
